(19) United States
(12) Patent Application Publication
(10) Pub. No.: US 2009/0293898 A1
(43) Pub. Date: Dec. 3, 2009

(54) ASSEMBLY FOR EXTRACTING CONTENTS FROM CONTAINERS INCLUDING BOTTLES AND TUBES

(76) Inventor: Susan Elizabeth Young, Mahwah, NJ (US)

Correspondence Address: COWAN LIEBOWITZ & LATMAN P.C, 1133 AVENUE OF THE AMERICAS, 1133 AVENUE OF THE AMERICAS, NEW YORK, NY, 10036, US

(21) Appl. No.: 12/433,469

(22) Filed: Apr. 30, 2009

Related U.S. Application Data
(60) Provisional application No. 61/049,925, filed on May 2, 2008.

(51) Int. Cl. A45D 34/00; B05C 17/10

(52) U.S. Cl. 132/200; 15/236.01; 132/286

(57) ABSTRACT

A kit assembly for extracting leftover health and beauty product from one or more containers, the kit assembly including a plurality of scoops for extracting said leftover product from multiple regions of one or more containers, wherein each of the scoops is adapted to extract leftover product from at least one region of one of the containers.

### CROSS-REFERENCE TO RELATED APPLICATION

This application is a non-provisional patent application of provisional application Ser. No. 61/049,925, filed May 2, 2008, the entire disclosure of which is hereby incorporated by reference.

### BACKGROUND OF THE INVENTION

This invention relates to an assembly for extracting or removing contents from a variety containers, such as bottles and tubes, and in particular, for extracting left-over cosmetic or health and beauty-related product from such containers.

Cosmetic products and other health and beauty supplies are packaged and sold in a variety containers, most commonly in bottles and tubes. Some of the bottles commonly used for cosmetic products like lotions, cleansers and other semi-liquid formulations include a pump dispenser for dispensing the product from the bottle. When most of the product stored in the bottle or a tube is used up, the remaining product becomes difficult to extract. For example, pump dispensers often cannot reach and are unable to pump the remaining product on the bottom of the bottle since the open end of the pump dispenser's is no longer submersed in the product. Similarly, much of the remaining product stored in a tube cannot be squeezed out. As a result, users dispose the remaining product with the container once they are no longer able to easily remove the product from the container.

The amount of the leftover product disposed with the container is often sufficient for multiple additional applications by the user. In addition, disposal of cosmetic products is often harmful to the environment. It is therefore desirable to extract as much product as possible from the containers so as to result in cost savings to the user and reducing the possibility of harming the environment.

### SUMMARY OF THE INVENTION

The above and other objects are realized in a kit assembly for extracting leftover health and beauty product from one or more containers, the kit assembly including a plurality of scoops for extracting leftover product from multiple regions of the one or more containers, wherein each of the scoops is adapted to extract the leftover product from at least one region of one of the containers. In certain embodiments, the kit assembly also includes an extension member adapted for use with each of the plurality of scoops for extending a scoop's reach when the extension member is used with the scoop. The scoops and the extension member are formed from plastic material that is flexible or semi-flexible.

The plurality of scoops include one or more of a first scoop for extracting leftover product from sidewall regions of bottle containers, a second scoop for extracting leftover product from a top region of the bottle containers, a third scoop for extracting leftover product from a bottom region of the bottle containers, a fourth scoop for extracting leftover product from a top region of tube containers, a fifth scoop for extracting leftover product from a bottom region of the tube containers and a sixth scoop for extracting leftover product from a sidewall region of the tube containers. Each of the first, second, third, fourth, fifth and sixth scoops include first and second opposing end portions and have different configurations of the second end portions so as to facilitate extraction of the leftover product from the respective regions of the containers.

The extension member has a cylindrical shape and includes an opening through the extension member's length. A straw from a pump dispenser in a container can be used as the extension member. Each of the scoops includes first and second opposing end portions, wherein the first end portion is insertable into the opening in the extension member.

An extracting assembly having a scoop for extracting leftover product from at least one region of one or more containers and an extension member for use with the scoop to extend the scoop's reach, and a method of extracting leftover health and beauty product from one or more containers are also disclosed. In addition, a combination of a container and an extracting assembly and a method of using such combination are disclosed.

### BRIEF DESCRIPTION OF THE DRAWINGS

The features and aspects of the present invention will become more apparent upon reading the following detailed description in conjunction with the accompanying drawings, in which:

FIG. 1 shows a kit assembly including a plurality of scoops for extracting leftover product from multiple regions of the container;

FIG. 2 shows a straw extender for use in bottles without a pump dispenser;

FIGS. 3A and 3B show front and side views of a bottle side scoop;

FIGS. 4A and 4B show front and side views of a bottle top scoop;

FIGS. 5A and 5B show front and side views of a bottle bottom scoop;

FIGS. 6A and 6B show front and side views of a tube top scoop;

FIGS. 7A and 7B show front and side views of a tube bottom scoop;

FIGS. 8A and 8B show front and side views of a tube side scoop;

FIGS. 9A-9H show the use of bottle side scoop, bottle bottom scoop and bottle top scoop with bottles that have a pump dispenser; and

FIGS. 10A and 10B show front and side views of a universal scoop.

### DETAILED DESCRIPTION OF THE INVENTION

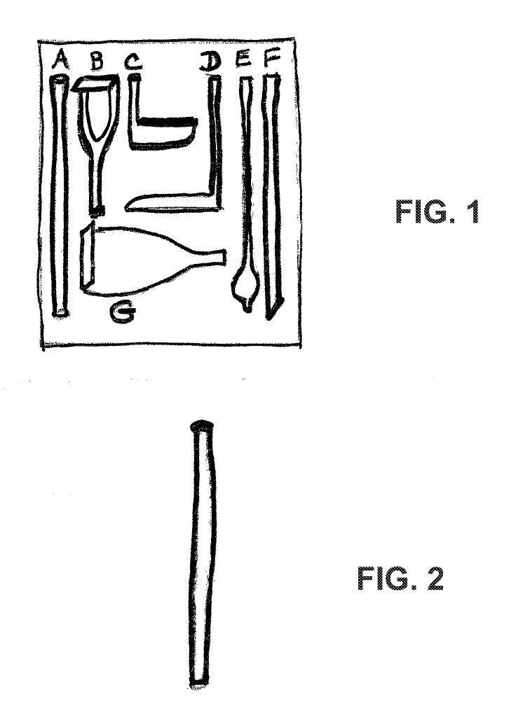

FIG. 1 shows an all-inclusive kit assembly 1 which includes items A-G, including a plurality of scoops for extracting leftover product from multiple regions of the container. In particular, items A-G of the assembly 1 are used for extracting leftover cosmetic and other health and beauty products from bottle and tube containers, including but not limited to bottles with pump dispensers. As described herein below, item A can be used together with items B-F of the kit assembly 1 so as to provide an extension when accessing the container. Items B-D in the all-inclusive kit assembly 1 are used for extracting leftover product stored in bottles while items E-G are used for extracting leftover product stored in tubes. Each of the items A-G is formed from flexible or semi-flexible plastic or similar materials, and are shown in more detail in FIGS. 2-8B.

FIG. 2 shows item A of the kit assembly 1 which is a straw extender 2 for use together with tubes and bottles that do not include a pump dispenser. The extender is adapted to couple with items B-F so as to extend the reach of the user inside the bottle or tube. The extender 2 is cylindrical in shape, i.e. such as a drinking straw-like shape, and the size or diameter of the opening through the length of the extender is such that it is able to receive and retain therein any one of items B-F. In this way, one of items B-F can be inserted into the straw extender and retained in an engaged or coupled state while being used to remove leftover product.

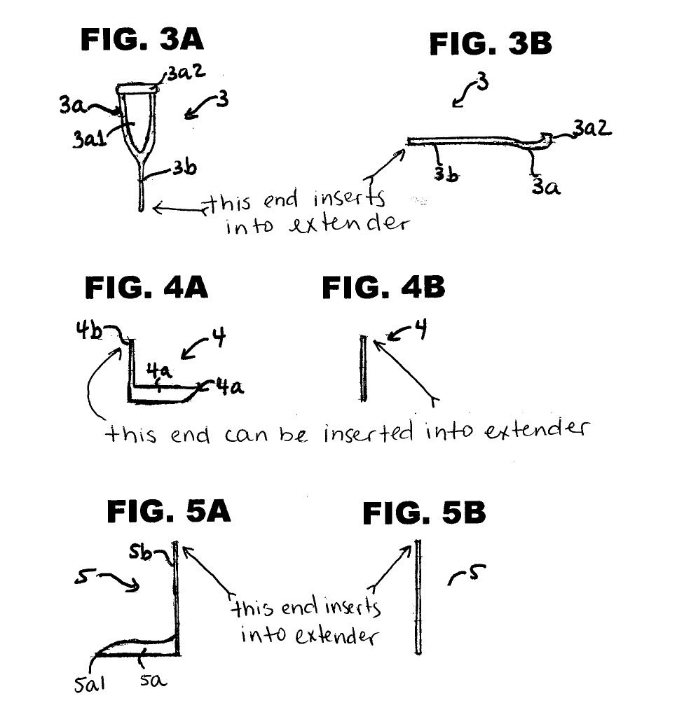

FIGS. 3A and 3B show a front view and a side view of item B of the kit assembly 1 which is a bottle side scoop 3. The bottle side scoop is used for scooping one or more sides of the bottle to extract leftover product on the sides of the bottle. In particular, one portion of the bottle side scoop is a widened portion 3a, which is visible from the front in FIG. 3A and which is used for scooping the leftover product from the bottle sidewalls. As shown in FIG. 3A, the widened portion 3a of the bottle side scoop 3 has a central through aperture 3a1 which provides flexibility to the scoop so that it can adapt to the shape of the bottle's sidewalls when used. The widened portion 3a may have a curved shape when viewed from the side (FIG. 3B) and also includes an angled end 3a2 which forms a scooping edge to assist in extracting the leftover product.

The scoop also has a narrowed portion 3b which can be inserted into the straw extender A of the assembly 1 so as to extend the length of the scoop to allow the user to reach farther into the bottle and to provide a handle for the user. When used with bottles that include a pump dispenser, the end of the narrowed portion 3b of the scoop 3 can be inserted into the straw of the pump dispenser instead of using the extender A.

FIGS. 4A and 4B show front and side views of unit C of the assembly kit 1 which is a bottle top scoop 4 for extracting leftover product collected at or near the top of the bottle, such as in an area near the bottle's neck. As shown, the bottle top scoop 4 includes a scooping portion 4a adapted to extract product from the top area of the bottle and a narrowed portion 4b adapted to be inserted into the extender A or a straw of a bottle pump dispenser. In the illustrative embodiment shown, the scooping portion 4a extends substantially perpendicular to the narrowed portion 4b at or near one end of the narrowed portion, and has a substantially straight top edge and a bottom edge with a rounded end portion which forms a pointed tip 4a1 at an intersection with the top edge.

FIGS. 5A and 5B show front and side views of unit D of the assembly kit which is a bottle bottom scoop 5 for extracting leftover product from the bottom of the bottle. The bottle bottom scoop 5 includes a scooping portion 5a adapted to extract leftover product on the bottom of the bottle and a narrowed portion 5b adapted to be inserted into the extender or a straw of the bottle pump dispenser. As shown in FIG. 5A, the scooping portion 5a extends substantially perpendicular to the narrowed portion 5b at or near one end of the narrowed portion. The scooping portion 5a has a substantially straight bottom edge so as to align with the bottom or base of the bottle when the scoop is inserted into the bottle, and a curved upper edge which forms a pointed tip 5a1 at an intersection with the bottom edge.

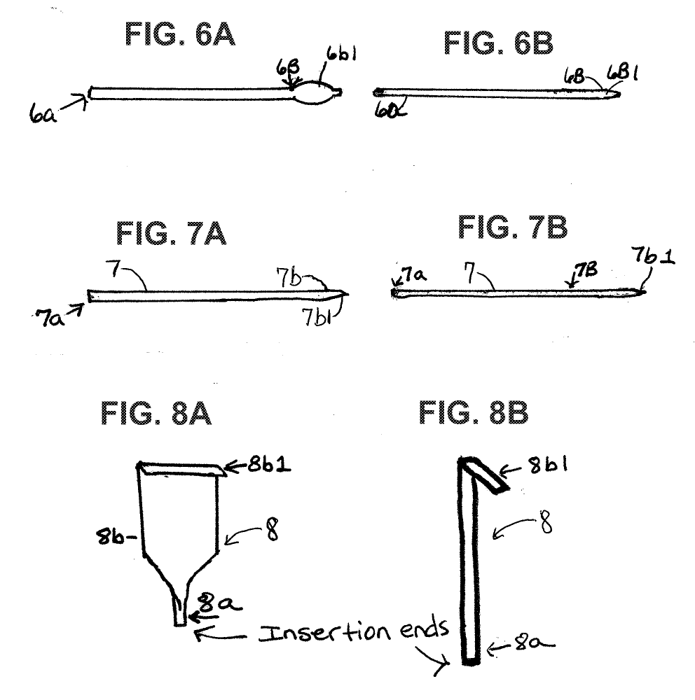

As mentioned herein above, items E-F of the assembly kit 1 are used for extracting leftover product stored in a tube container. FIGS. 6A and 6B show front and side views of item E of the assembly kit 1 which is a tube top scoop 6 for extracting leftover product from a top portion of a tube, i.e. a portion of the tube near the opening for dispensing the product. The tube top scoop 6 includes an insertion end 6a which is adapted to be inserted into the extender A shown of the assembly 1, and a scooping portion 6b at an opposing end which includes rounded flap-shaped portions 6b1 extending outwardly and adapted for extracting leftover product from the top portion of the tube. The flap-shaped portions 6b1 are sufficiently flexible so that the scooping end can be inserted into the tube through the tube's opening.

FIGS. 7A and 7B show front and side views of item E of the kit assembly 1 which is a tube bottom scoop 7 and can be used for extracting leftover product from a bottom portion of a tube, i.e. a portion of the tube opposing the top end of the tube. The tube bottom scoop 7 has a rod-like shape and includes a first end 7a which is adapted to be inserted into the extender A and a second end 7b which is used for extracting leftover product from the bottom of the tube. The second end 7b has a pointed tip 7b1 which allows the scoop 7 to access the leftover product at the bottom end of the tube which is typically narrowed as a result of sealing the tube's sidewalls to one another.

FIGS. 8A and 8B show front and side views of item G of the kit assembly 1 which is a tube side scoop 8 adapted to scoop the sides of the tube. As shown in FIG. 8A, the tube side scoop 8 includes a narrowed portion 8a which is adapted to be inserted into the extender A and a widened scooping portion 8b which has a spatula-shaped configuration with an angled portion 8b1 formed at its end which is used for collecting the leftover product from tube sidewalls. When the tube side scoop 8 is used to remove leftover product from the sidewalls of the tube, one end of the tube is cut open to allow the tube side scoop 8 to access the product leftover in the tube.

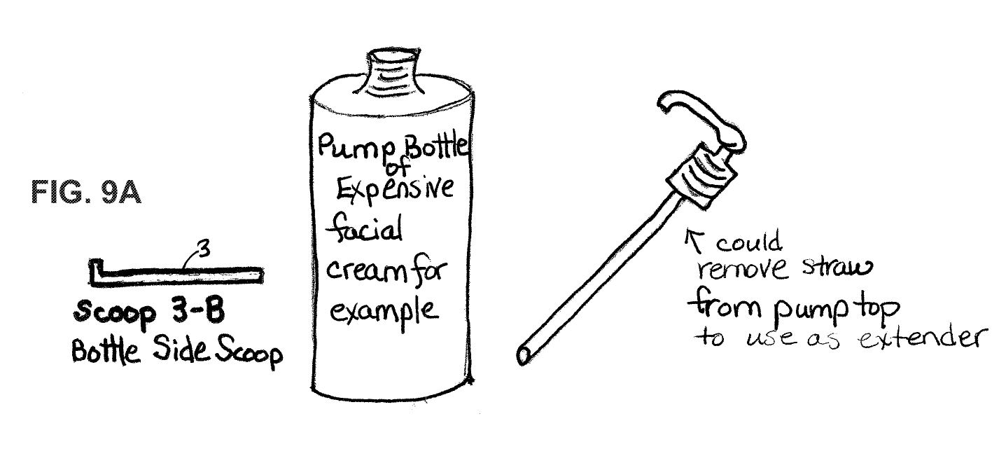

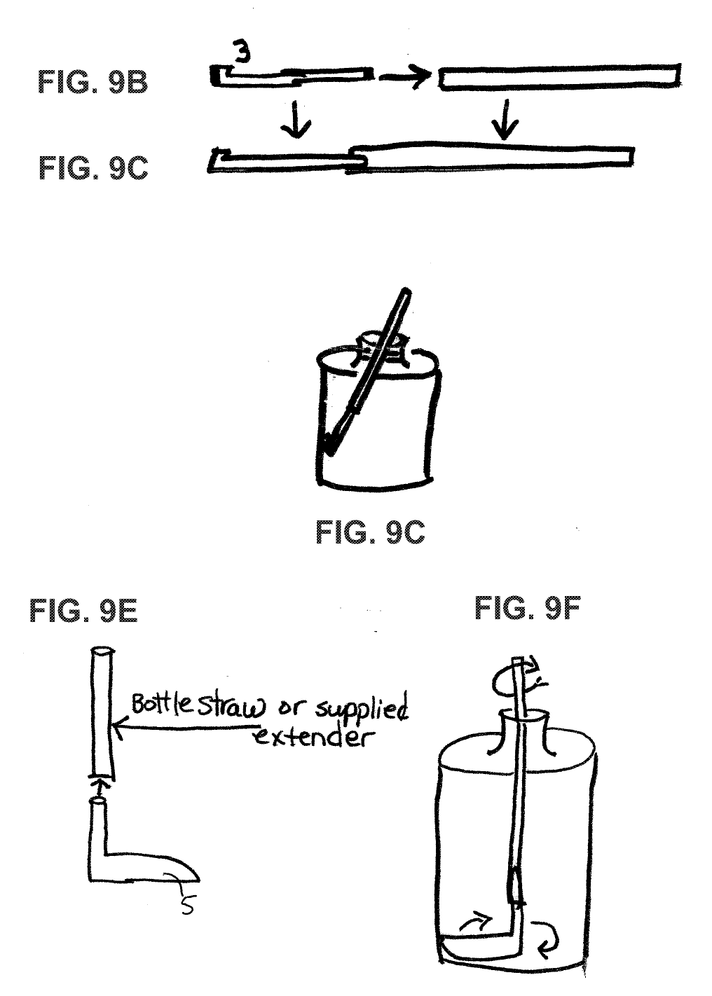

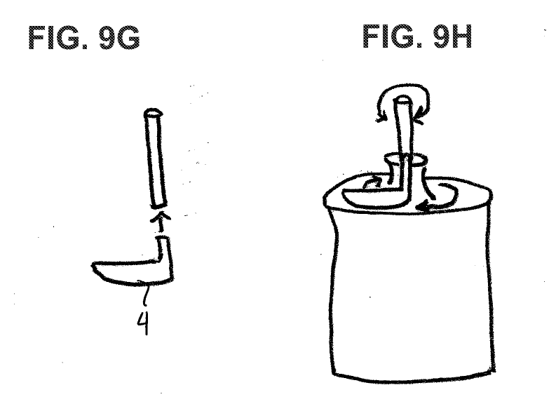

FIGS. 9A-9H show the use of bottle side scoop 3, bottle bottom scoop 5 and bottle top scoop 4 with bottles that have a pump dispenser. The kit assembly 1 can be used as shown in 9A-H when a user of a product, such as a facial cream or a lotion or the like, stored in a bottle with a pump dispenser can no longer pump out any more product using the pump dispenser. As shown in FIG. 9A, the first step is to remove the pump dispenser, including a straw, from the bottle container and to remove the straw from the pump dispenser. In the next steps, as shown in FIGS. 9B and 9C, an appropriate scoop is selected from items B-D of the kit assembly 1 and the narrow end portion of the selected scoop is inserted into the straw from the pump dispenser to form a scoop assembly as shown in FIG. 9C. The straw creates a handle having an appropriate size and length relative to the bottle size and the resulting scoop assembly can be inserted into the bottle as shown in FIG. 9D and can be used to extract leftover product that was previously unreachable to the pump dispenser. When the scoop is in the bottle, it can be ‘squeegeed’ up the sidewalls of the bottle to collect any leftover product from the sidewalls.

In the example shown in FIG. 9D, the scoop selected and inserted into the bottle is the bottle side scoop shown in FIGS. 3A and 3B so that the leftover product can be extracted from the sidewalls of the bottle. The bottle top scoop 4 and the bottle bottom scoop 5 can be similarly used with the straw of the pump dispenser and inserted into the bottle for extracting or removing leftover product near the top and bottom, respectively, of the bottle. FIG. 9E shows the bottle bottom scoop 5 being inserted into the straw to form a scoop assembly and FIG. 9F shows the scoop assembly being used to extract the leftover product from the bottom of the bottle. In particular, as shown in FIG. 9F, the scoop assembly with the bottle bottom scoop 5 is inserted into the bottle standing straight up from the center of the bottom, the straw is then rotated so as to collect some or all of the leftover product on the bottom of the bottle and when sufficient product is collected by the scoop for the user's application, the scoop assembly is withdrawn from the bottle.

FIG. 9G shows the bottle top scoop 4 being inserted into the straw to form a scoop assembly and FIG. 9H shows the scoop assembly being used to extract the leftover product from the top area of the bottle near the bottle's opening. In particular, when the scoop assembly with the top scoop 4 is inserted into the bottle, the straw is rotated so as to cause the scoop to turn around the top of the bottle to collect the leftover product in the top area of the bottle. When sufficient leftover product is collected, the scoop assembly is withdrawn from the bottle for use by the user.

In the illustrative example shown in FIGS. 9A-9H, the bottle side scoop is first used to extract the product on the sidewalls of the bottle, and when all of the leftover product is removed from the sidewalls, the side scoop 3 is removed from the straw and the bottle bottom scoop 5 is used for extracting the leftover product on the bottom of the bottle as shown in FIGS. 9E and 9F. When all of the leftover product at the bottom of the bottle is used up by the user, the bottle top scoop 4 is used to extract any leftover product collected near the top of the bottle, as shown in FIGS. 9G and 9H. After each use, the straw and the scoop used for extracting the leftover product is cleaned and can be reused in future uses. It is understood that the selection and use order of the scoops 3-5 is merely illustrative and that the scoops can be used in any order desired by the user and depending on the product and the shape of the bottle.

Although FIG. 1 shows the kit assembly 1 as including all of the items A-G, it is also contemplated that each of the items B-G may be sold individually, with or without the straw extender 2. Moreover, one or more scoops 3-8 (items B-G) may be included with the product at the time of sale or in the product's packaging for use together with the product's container. In such cases, the straw extender 2 (item A) may also be included for use with the scoops included with the product. Alternatively, if the product's dispensing assembly already includes a straw, the straw extender may be omitted and the scoops included with the product would be used in the manner shown in FIGS. 9A-9H.

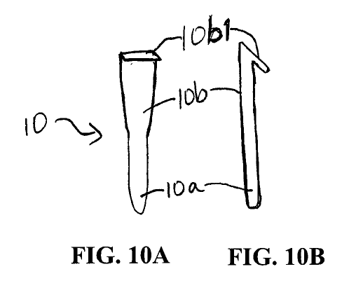

FIGS. 10A and 10B show front and side views of another embodiment of a scoop 10 which can be used and sold independently or as part of the all-inclusive kit assembly 1. The scoop 10 can be used for extracting leftover product from at least one region of the container, and preferably from multiple regions of the container and thus can be used as a universal scoop. As shown in FIGS. 10A and 10B, the scoop includes first and second opposing end portions 10a and 10b. The first end portion 10a can be used for holding the scoop 10 or can be inserted into the extender shown in FIG. 2. In certain embodiments, the first end portion 10a can be extended so as to have a greater length to provide sufficient reach for the user when accessing leftover product. The second end portion 10b includes a scoop portion, formed as a planar or substantially flat portion, and an angled scooping end 10b1 which forms an angle, shown as an acute angle, with the planar scoop portion. The width of the planar scoop portion can be varied, so that in some embodiments, the planar scoop portion has the same width as the first end portion 10a of the scoop and in other embodiments, the planar scoop portion has a greater width than the first end portion 10a of the scoop.

In all cases it is understood that the above-described arrangements are merely illustrative of the many possible specific embodiments which represent applications of the present invention. For example, the scoops shown in FIGS. 3A-8B can be used without the straw extender and the length of the insertion end of each of the scoops shown in FIGS. 3A-8B can be increased so that the extender is not needed and sufficient reach is provided to access the leftover product. In addition, the scoops shown in FIGS. 1-10B can be used for extracting products other than health and beauty products from a variety of containers. Numerous and varied other arrangements can be readily devised in accordance with the principles of the present invention without departing from the spirit and scope of the invention.

What is claimed is:

1. A kit assembly for extracting leftover health and beauty product from one or more containers, said kit assembly including a plurality of scoops for extracting said leftover product from multiple regions of said one or more containers, wherein each of said scoops is adapted to extract said leftover product from at least one region of one of said containers.

2. A kit assembly in accordance with said claim 1, wherein said scoops are formed from plastic material that is one of flexible and semi-flexible.

3. A kit assembly in accordance with claim 1, wherein said plurality of scoops include one or more of:
a first scoop for extracting leftover product from sidewall regions of bottle containers;
a second scoop for extracting leftover product from a top region of said bottle containers;
a third scoop for extracting leftover product from a bottom region of said bottle containers;
a fourth scoop for extracting leftover product from a top region of tube containers;
a fifth scoop for extracting leftover product from a bottom region of said tube containers; and
a sixth scoop for extracting leftover product from a sidewall region of said tube containers.

4. A kit assembly in accordance with claim 3, wherein said first scoop includes first and second opposing end portions, wherein:
said first end portion comprises a rod-shaped elongated member; and
said second end portion is widened in a first plane so as to form a widened scoop portion, said widened scoop portion having a central aperture and a scooping end angled in a second plane different from said first plane.

5. A kit assembly in accordance with claim 3, wherein said second scoop includes first and second opposing end portions, wherein:
said first end portion comprises a rod-shaped elongated member; and
said second end portion includes a scooping end portion extending in a direction substantially perpendicular to said first end portion and including an upper straight edge facing the top region of said bottle container when said second scoop is inserted into said bottle container and a rounded lower edge forming a pointed tip with said upper straight edge.

6. A kit assembly in accordance with claim 3, wherein said third scoop includes first and second opposing end portions, wherein:
said first end portion comprises a rod-shaped elongated member; and
said second end portion includes a scooping end portion extending in a direction substantially perpendicular to said first end portion and including a lower straight edge facing the bottom region of said bottle container when said third scoop is inserted into said bottle container and a curved upper edge forming a pointed tip with said lower straight edge.

7. A kit assembly in accordance with claim 3, wherein said fourth scoop comprises an elongated rod-shaped member having first and second end portions, wherein said second end portion includes one or more flexible rounded flap portions extending outwardly from one or more sides of said elongated member.

8. A kit assembly in accordance with claim 3, wherein said fifth scoop comprises an elongated rod-shaped member having opposing first and second ends, wherein said second end portion includes a pointed tip adapted to access leftover product at said bottom region of said tube container.

9. A kit assembly in accordance with claim 3, wherein said sixth scoop includes first and second end portions, wherein:
said first end portion comprises a rod-shaped elongated member; and
said second end portion is widened in a first plane so as to form a widened scoop portion, said widened scoop portion having a scooping end angled in a second plane different from said first plane.

10. A kit assembly for extracting leftover health and beauty product from one or more containers, said kit assembly comprising:
a plurality of scoops for extracting said leftover product from multiple regions of said one or more containers; and
an extension member adapted for use with each of said plurality of scoops for extending a scoop's reach when said extension member is used with said scoop.

11. A kit assembly in accordance with claim 10, wherein said scoops and said extension member are formed from plastic material that is one of flexible and semi-flexible.

12. A kit assembly in accordance with claim 10, wherein:
said extension member has a cylindrical shape and includes an opening through said extension member's length; and
each of said scoops includes first and second opposing end portions, said first end portion being insertable into said opening in said extension member.

13. A kit assembly in accordance with claim 12, wherein said plurality of scoops include one or more of:
a first scoop for extracting leftover product from sidewall regions of bottle containers, said second end portion of said first scoop being widened in a first plane so as to form a widened scoop portion, said widened scoop portion having a central aperture and a scooping end angled in a second plane different from said first plane;
a second scoop for extracting leftover product from a top region of said bottle containers, said second end portion of said second scoop including a scooping end portion extending in a direction substantially perpendicular to said first end portion and including an upper straight edge facing the top region of said bottle container when said second scoop is inserted into said bottle container and a rounded lower edge forming a pointed tip with said upper straight edge;
a third scoop for extracting leftover product from a bottom region of said bottle containers, said second end portion of said third scoop including a scooping end portion extending in a direction substantially perpendicular to said first end portion and including a lower straight edge facing the bottom region of said bottle container when said third scoop is inserted into said bottle container and a curved upper edge forming a pointed tip with said lower straight edge;
a fourth scoop for extracting leftover product from a top region of tube containers, said fourth scoop comprising an elongated rod-shaped member and said second end portion of said elongated member of said fourth scoop including one or more flexible rounded flap portions extending outwardly from one or more sides of said elongated member;
a fifth scoop for extracting leftover product from a bottom region of said tube containers, said fifth scoop comprising an elongated rod-shaped member and said second end portion of said elongated member of said fifth scoop including a pointed tip; and
a sixth scoop for extracting leftover product from a sidewall region of said tube containers, said second end portion of said sixth scoop being widened in a first plane so as to form a widened scoop portion and said widened scoop portion includes a scooping end angled in a second plane different from said first plane.

14. An extracting assembly for extracting leftover health and beauty product from one or more containers, said extracting assembly comprising a scoop for extracting said leftover product from at least one region of said one or more containers.

15. An extracting assembly in accordance with claim 14, said extracting assembly further comprising an extension member for use with said scoop for extending said scoop's reach when said extension member is used with said scoop.

16. An extracting assembly in accordance with claim 15, wherein:
said extension member has a cylindrical shape and includes an opening through said extension member's length; and
said scoop includes first and second opposing end portions, said first end portion being insertable into said opening in said extension member.

17. An extracting assembly in accordance with claim 16, wherein said scoop is one of:
a first scoop for extracting leftover product from sidewall regions of bottle containers, said second end portion of said first scoop being widened in a first plane so as to form a widened scoop portion, said widened scoop portion having a central aperture and a scooping end angled in a second plane different from said first plane;
a second scoop for extracting leftover product from a top region of said bottle containers, said second end portion of said second scoop including a scooping end portion extending in a direction substantially perpendicular to said first end portion and including an upper straight edge facing the top region of said bottle container when said second scoop is inserted into said bottle container and a rounded lower edge forming a pointed tip with said upper straight edge;
a third scoop for extracting leftover product from a bottom region of said bottle containers, said second end portion of said third scoop including a scooping end portion extending in a direction substantially perpendicular to said first end portion and including a lower straight edge facing the bottom region of said bottle container when said third scoop is inserted into said bottle container and a curved upper edge forming a pointed tip with said lower straight edge;
a fourth scoop for extracting leftover product from a top region of tube containers, said fourth scoop comprising an elongated rod-shaped member and said second end portion of said elongated member of said fourth scoop including one or more flexible rounded flap portions extending outwardly from one or more sides of said elongated member;
a fifth scoop for extracting leftover product from a bottom region of said tube containers, said fifth scoop comprising an elongated rod-shaped member and said second end portion of said elongated member of said fifth scoop including a pointed tip; and
a sixth scoop for extracting leftover product from a sidewall region of said tube containers, said second end portion of said sixth scoop being widened in a first plane so as to form a widened scoop portion and said widened scoop portion includes a scooping end angled in a second plane different from said first plane.

18. A method of extracting leftover health and beauty product from one or more containers using an extracting assembly in accordance with claim 15, said method comprising:
coupling said extension member with said scoop so as to extend said scoops reach;
inserting said scoop into a container; and
extracting leftover product from at least one region of said container using said scoop.

19. A combination of a container housing a health or beauty product therein and an extracting assembly for extracting leftover product from said container, said extracting assembly comprising at least one scoop for extracting said leftover product from at least one region of said container.

20. A combination of a container and an extracting assembly in accordance with claim 19, wherein one of:
said extracting assembly further comprises an extension member for use with said at least one scoop for extending said scoop's reach when said extension member is used with said scoop; and
said container includes a pump dispenser comprising a straw and said scoop of said extracting assembly is adapted to be used with said straw form said pump dispenser so as to extend said scoop's reach when said scoop is used with said straw.

21. A method of using a combination of a container and an extracting assembly in accordance with claim 19, said method comprising:
extracting said health or beauty product from said container until said product is no longer easily accessible;
inserting said scoop of said extracting assembly into said container when said product is no longer easily accessible from said container; and
extracting leftover product from at least one region of said container using said scoop.

22. An extracting assembly for extracting leftover product from one or more containers, said extracting assembly comprising a scoop including first and second end portions, wherein said first end portion comprises an elongated member and said second end portion comprises a planar scoop portion having an angled scooping end, said scooping end forming one of an angle and an acute angle with said planar scoop portion.
